(19) United States
(12) Patent Application Publication
(10) Pub. No.: US 2006/0070481 A1
(43) Pub. Date: Apr. 6, 2006

(54) Control lever for active geometry control suspension

(75) Inventor: Young Kwang Kim, Yongin-si (KR)

Correspondence Address: GREENBLUM & BERNSTEIN, P.L.C., 1950 ROLAND CLARKE PLACE, RESTON, VA, 20191, US

(73) Assignee: HYUNDAI MOBIS CO., LTD., Seoul (KR)

(21) Appl. No.: 11/024,411

(22) Filed: Dec. 30, 2004

(30) Foreign Application Priority Data
Oct. 6, 2004 (KR) 2004-0079466

(51) Int. Cl. G05G 1/04

(52) U.S. Cl. 74/519

(57) ABSTRACT

A control lever for an active geometry control suspension includes a lever body formed with an outer coupling portion configured to be coupled to an actuator and an inner longitudinal through-bore, a tubular spacer inserted into the through-bore to penetrate therethrough, bearings interposed between the through-bore of the lever body and the spacer, sealing members installed at one side of each of the bearings between the through-bore of the lever body and the spacer, and washers installed outside each of the sealing members at ends of the through-bore.

### RELATED APPLICATIONS

The present disclosure relates to subject matter contained in Korean Application No. 10-2004-0079466, filed on Oct. 6, 2004, which is herein expressly incorporated by reference its entirely.

### BACKGROUND OF THE INVENTION

1. Field of the Invention

The present invention relates to a control lever for an active geometry control suspension, and more particularly, to a control lever for an active geometry control suspension capable of actively controlling a toe-in angle of a rear wheel of a vehicle by means of an electrically operating actuator, wherein foreign substances are prevented from entering a clearance between a bearing and a control lever and the control lever is smoothly rotated after assembly thereof.

2. Description of the Related Art

An active geometry control suspension (AGCS) is simply referred to as an “active suspension” and is a system capable of actively controlling a toe-in angle of a rear wheel of a vehicle using an electrically operating actuator.

FIG. 1 is a perspective view showing an example of a conventional active geometry control suspension. A linear reciprocating motion of an actuator 10 is converted into a rotational motion of a control lever 20 through a yoke 21 of the control lever 20. The rotational motion is then converted into a vertical linear motion of a fixing portion of an assist arm 30 connected to the control lever 20. When the reference length of a knuckle 40 of the assist arm 30 is changed, the knuckle 40 is rotated to change a toe-in angle a.

FIG. 2 is a perspective view showing the control lever for the conventional active geometry suspension, and FIG. 3 is a sectional view of the control lever taken along line A-A of FIG. 2, with a cross member mounted therein. Bearings 80 are installed in the body of the control lever 20 at both ends thereof, a hinge bolt 50 is inserted into through-holes of the bearings, and the cross member 60 is coupled to and a nut 70 is then fastened to the hinge bolt.

However, in the aforementioned structure of the control lever for the active geometry control suspension, there is a disadvantage in that foreign substances are introduced into a clearance between the bearing and the cross member and accelerate wear of the bearing. Further, there is a problem in that upon fastening of the nut during the assembly process, fastening torque deforms a bracket on the side of the cross member, thereby restraining the control lever and making the rotation of the control lever impossible.

### SUMMARY OF THE INVENTION

The present invention is conceived to solve the problems in the prior art. An object of the present invention is to provide a control lever for an active geometry control suspension, wherein foreign substances are prevented from being introduced into a clearance between a bearing and the control lever and accelerating wear of the bearing, and it is possible to avoid a phenomenon in which fastening torque applied when a nut is fastened to an insertion portion of a hinge bolt during an assembly process deforms a bracket on the side of a cross member to restrain the control lever and inhibit the rotation of the control lever.

According to the present invention for achieving the object, there is provided a control lever for an active geometry control suspension, comprising a lever body formed with an outer coupling portion coupled to an actuator and an inner longitudinal through-bore; a tubular spacer inserted into the through-bore to penetrate therethrough; bearings interposed between the through-bore of the lever body and the spacer; sealing members installed at one side of each of the bearings between the through-bore of the lever body and the spacer; and washers installed outside each of the sealing members at ends of the through-bore.

### BRIEF DESCRIPTION OF THE DRAWINGS

The above and other objects, features and advantages of the present invention will become apparent from the following description of a preferred embodiment given in conjunction with the accompanying drawings, in which:

FIG. 1 is a perspective view showing an example of a conventional active geometry control suspension;

FIG. 2 is a perspective view showing a control lever for the conventional active geometry suspension;

FIG. 3 is a sectional view of the control lever taken along line A-A of FIG. 2, with a cross member mounted therein;

FIG. 4 is a perspective view showing an external appearance of an embodiment of a control lever for an active geometry control suspension according to the present invention;

FIG. 5 is an exploded perspective view showing the embodiment of the control lever for the active geometry control suspension according to the present invention; and

FIG. 6 is a sectional view of the control lever for the active geometry control suspension according to the present invention.

### DETAILED DESCRIPTION OF THE INVENTION

Hereinafter, a preferred embodiment of the present invention will be described in detail with reference to the accompanying drawings.

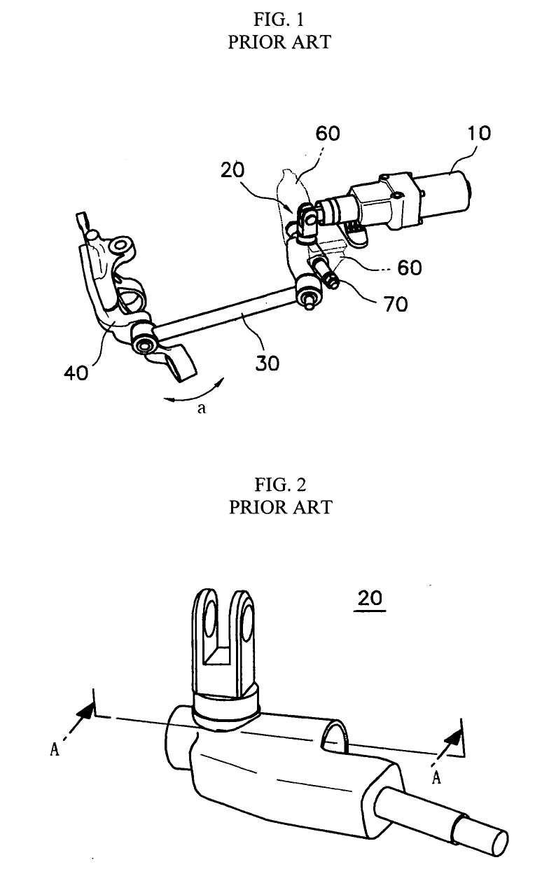

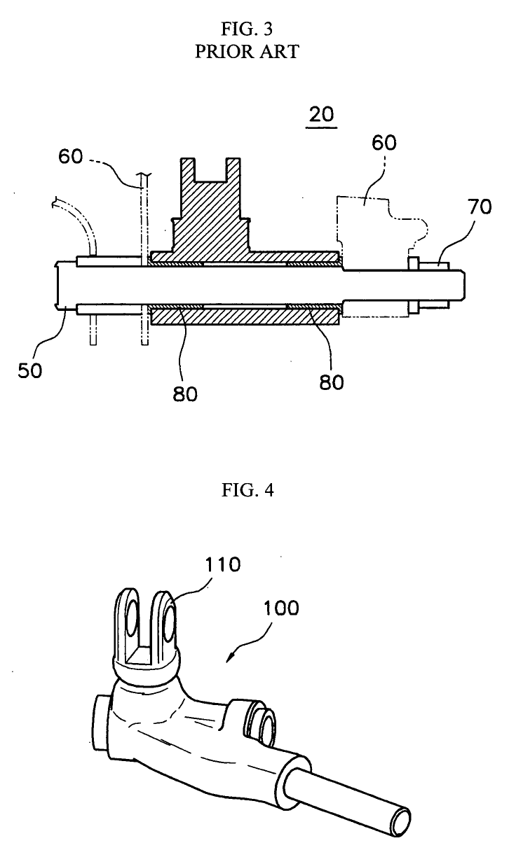

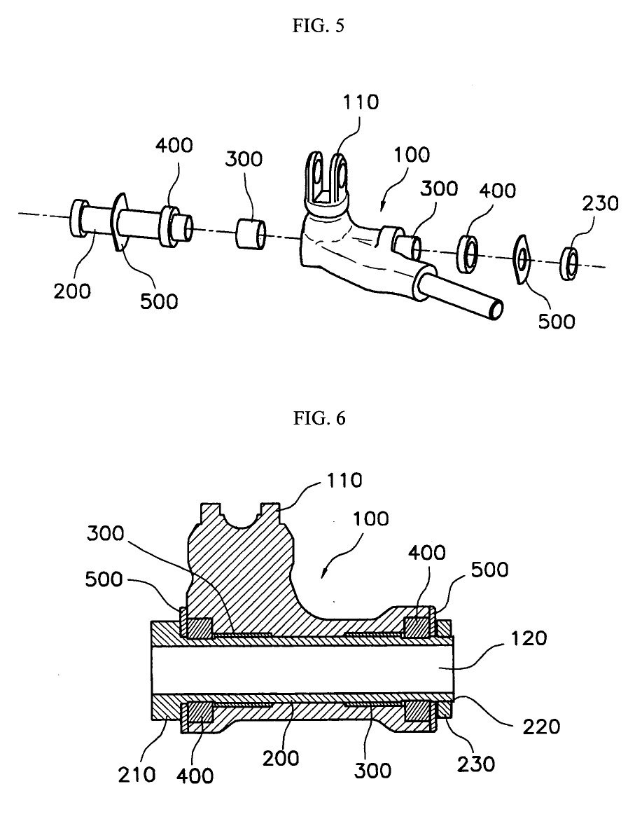

FIG. 4 is a perspective view showing an external appearance of an embodiment of a control lever for an active geometry control suspension according to the present invention, and FIG. 5 is an exploded perspective view thereof. The control lever for the active geometry control suspension according to the present invention comprises a lever body 100 formed with an outer coupling portion 110 coupled to an actuator (see FIG. 1) and an inner longitudinal through-bore 120; a tubular spacer 200 inserted into the through-bore 120 to penetrate therethrough; bearings 300 interposed between the through-bore 120 of the lever body 100 and the spacer 200; sealing members 400 installed at one side of each of the bearings 300 between the through-bore 120 of the lever body 100 and the spacer 200; and washers 500 installed outside each of the sealing members 400 at ends of the through-bore 120.

FIG. 6 is a sectional view of the control lever for the active geometry control suspension according to the present invention. Preferably, the spacer 200 has one end formed with a head portion 210 for providing a support against the through-bore 120 of the lever body 100 and the other end formed with a thread portion 220, and a nut 230 is further provided to be fastened to the thread portion 220 of the spacer 200, so that the spacer 200 is firmly fixed to the lever body 100 while the lever body 100 is smoothly operated.

An oil seal is preferably used as the sealing member 400 to prevent introduction of foreign substances.

Next, the operation and effects of the present invention will be described below with reference to FIGS. 4 to 6.

As described above, the present invention is to actively control the toe-in angle of the rear wheel of the vehicle using the actuator and is the same as a conventional one in view of their operation. However, the bearings 300 are first inserted into the through-bore 120 of the lever body 100 at both ends of the through-bore, the sealing members 400 are inserted thereinto outside of the bearings, and the washers 500 are installed at the both ends of the through-bore 120 in a state where the sealing members 400 and the bearings 300 are restrained.

In this installed state, the spacer 200 is inserted and the nut 230 is fastened to the thread portion 220 of the spacer 200 so that the lever body 100 can be smoothly operated.

Therefore, as can be seen from the sectional view shown in FIG. 6, the bearings 300 and the sealing members 400 are disposed between the through-bore 120 of the lever body 100 and the spacer 200.

With the sealing members 400 placed at the both ends of the through-bore 120, foreign substances are prevented from being introduced into the through-bore from the outside. Further, due to the spacer 200, the lever body 100 is prevented from being restrained during the assembly process, thereby ensuring the smooth rotation of the lever body and preventing loosening of the nut 230.

As described above, the present invention is directed to a control lever for an active geometry control suspension, and more particularly, to a control lever for an active geometry control suspension capable of actively controlling a toe-in angle of a rear wheel of a vehicle by means of an electrically operating actuator. According to the present invention, there are advantages in that foreign substances are prevented from being introduced into a clearance between a bearing and the control lever and accelerating wear of the bearing, and it is possible to avoid a phenomenon in which fastening torque applied when a nut is fastened to an insertion portion of a hinge bolt during an assembly process deforms a bracket on the side of a cross member to restrain the control lever and inhibit the rotation of the control lever.

The embodiment is merely an example for specifically describing the technical spirit of the present invention. The scope of the present invention is not limited to the embodiment or the accompanying drawings.

1. A control lever for an active geometry control suspension, comprising:
a lever body formed with an outer coupling portion configured to be coupled to an actuator and an inner longitudinal through-bore;
a tubular spacer inserted into the through-bore to penetrate therethrough;
bearings interposed between the through-bore of the lever body and the spacer;
sealing members installed at one side of each of the bearings between the through-bore of the lever body and the spacer; and
washers installed outside each of the sealing members at ends of the through-bore.

2. The control lever as claimed in claim 1, further comprising a nut configured to be fastened to a thread portion of the spacer, wherein the spacer has one end formed with a head portion that provides a support against the through-bore of the lever body and the other end formed with the thread portion.
